(19) United States
(12) Patent Application Publication
(10) Pub. No.: US 2024/0232914 A1
(43) Pub. Date: Jul. 11, 2024

(54) Method and Apparatus for Tracking User Behavior Based on Encoded Image Identification, User Location and Purchase Product Information

(71) Applicant: Stephen Verneil Shepherd, Suwanee, GA (US)

(72) Inventor: Stephen Verneil Shepherd, Suwanee, GA (US)

(21) Appl. No.: 18/408,170

(22) Filed: Jan. 9, 2024

Related U.S. Application Data
(60) Provisional application No. 63/437,793, filed on Jan. 9, 2023.

(51) Int. Cl. G06Q 30/0201

(52) U.S. Cl. CPC G06Q 30/0201

(57) ABSTRACT

A method and apparatus for tracking user behavior involves detecting image identifying information, user location information, and user purchase product information using a computing device. The method further includes detecting identifying information of the user and transmitting the detected information to one or more remote computing devices via a network. The one or more remote computing devices compute a value based on the detected information and save the value along with the identifying information in a memory. This method enables the tracking of user behavior by analyzing various data points, such as media viewed, user location, and purchase products, to generate valuable insights for targeted marketing and personalized user experiences.

### BACKGROUND

This application relates to systems and methods for tracking user behavior based on encoded image identification, user location and purchase product information.

Previous approaches for tracking user behavior have involved various methods and techniques to collect and analyze data related to user activities. One common approach has been to track user behavior through the use of cookies or other tracking technologies on websites and online platforms. These technologies collect information such as browsing history, clicked links, and search queries to create user profiles and deliver targeted advertisements. While this approach has been effective in tracking online user behavior, it does not provide a comprehensive solution for tracking user behavior across different media and offline activities.

Another approach to tracking user behavior involves the use of location-based services and mobile devices. By utilizing GPS or other location tracking technologies, user location information can be collected and analyzed to understand user behavior patterns and preferences. However, this approach is limited to tracking user behavior within the scope of location-based services and does not capture user behavior related to media consumption or product purchases.

Additionally, some previous approaches have attempted to track user behavior by analyzing purchase data and transaction records. By collecting information on user purchases, such as product types, quantities, and frequencies, user behavior can be inferred and analyzed. However, this approach is limited to tracking user behavior solely based on purchase data and does not consider other factors such as media consumption or user location.

However, none of these approaches have provided a comprehensive solution that combines the features described in this disclosure. The present invention aims to address these limitations by providing a method for tracking user behavior that incorporates encoded image identifying information in media, user location information, and user purchase product information. By combining these different sources of data, a more comprehensive understanding of user behavior can be achieved, allowing for more accurate analysis and targeted marketing strategies.

### SUMMARY OF THE INVENTION

A method and apparatus for tracking user behavior based on encoded image identification, user location and purchase product information are disclosed.

In some aspects, the techniques described herein relate to a method for tracking a user's behavior including: detecting with a computing device at least one of image identifying information encoded in an image viewed by the user, user location information, and user purchase product information; detecting user identifying information; transmitting via a network to one or more remote computing devices the detected at least one of the image identifying information, user location information, and user purchase product information concurrently with the user identifying information; computing using the one or more remote computing devices a value based on the detected at least one of encoded image identifying information, user location information, and user purchase product information; and saving the value with the user identifying information in a memory using at least one of the one or more remote computing devices.

In some aspects, the techniques described herein relate to an apparatus for tracking a user's behavior including: a computing device configured to detect at least one of image identifying information encoded in an image viewed by the user, user location information, and user purchase product information; a bio tracking device configured to detect user identifying information while the user is viewing image; a transmitter to transmit via a network to one or more remote computing devices the detected at least one of the image identifying information, user location information, and user purchase product information concurrently with the user identifying information; and a remote computing device to compute a value based on the detected at least one of encoded image identifying information, user location information, and user purchase product information, said remote computing device configured to save the value with the user identifying information in a memory using at least one of the one or more remote computing devices.

In some aspects, the techniques described herein relate to a system for tracking a user's behavior including: one or more computing devices configured to detect at least one of image identifying information encoded in an image viewed by the user, user location information, and user purchase product information; a bio tracking device configured to detect user identifying information while the user is viewing image; a transmitter to transmit via a network to one or more remote computing devices the detected at least one of the image identifying information, user location information, and user purchase product information concurrently with the user identifying information; and one or more of the remote computing device to compute a value based on the detected at least one of encoded image identifying information, user location information, and user purchase product information, the one or more remote computing device configured to save the value with the user identifying information in a memory using at least one of the one or more remote computing devices.

### BRIEF DESCRIPTION OF THE DRAWINGS

FIG. 1 is a simplified schematic diagram of a system for tracking and incentivizing user behavior;

FIG. 2 is a simplified schematic diagram of an exemplary user computing device used in the system for tracking and incentivizing user behavior;

FIG. 3 is a simplified schematic diagram of an exemplary hosting computing device used in the system for tracking User Behavior;

FIG. 4 illustrates a flow diagram of a process used by an exemplary user compering device for tracking and incentivizing user behavior;

FIG. 5 illustrates a flow diagram of a process used by a host computing device for tracking and incentivizing user behavior; and

FIG. 6 illustrates a flow diagram of a process used by the host computing device for tracking and incentivizing user behavior to embed information in recorded media content.

### DETAILED DESCRIPTION

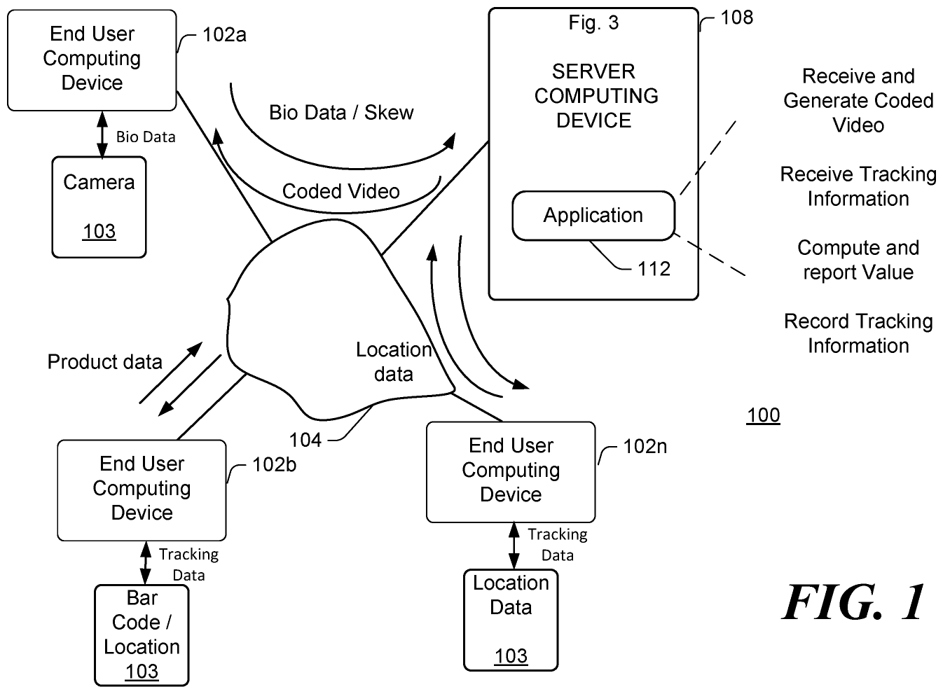

Referring to FIG. 1 there is shown a system 100 for tracking and incentivizing a user's behavior that includes end user computing devices (also referred to herein as “personal computing devices” or “mobile communication computing devices”) 102a-102n coupled via a network 104 to one or more network based server computing devices 108 (also referred to herein as a remote computing device or multiple remote computing devices). In one implementation, each of the End User computing devices 102a-102n may be connected to a tracking device 103. Tracking device 103 (also referred to herein as a bio tracking device) may be a camera or biometric sensor to detect biometric features of the user, bar codes, location data. Exemplary tracking devices 103 include a smart watch, a camera, a bio-feedback device, an Infrared reader, or a biometric tracking device. The tracking devices 103a-n may include a display and/or a global positioning sensor GPS to detect locations, bar codes, watermarks in videos or photographs, video encoding information, video identifying information and/or user identification information and/or user identifying information (and may include other sensors as described herein) during operation.

Server computing device 108 is described communicating directly with End User computing devices 102a-102n; however, such communication is for illustration purposes only and in a typical implementation server computing device 108 may communicate via network 104 to end user computing devices 102a-102n, other end user computing devices (not shown), and/or directly to a tracking device 103.

Server computing device 108 may be a network computer, host computer, network server, web server, email server or any computing device for hosting email communications applications and systems, one example of which includes a Microsoft® exchange server. Although end user computing devices 102a, 102b-102n and other client computing device are described as a personal computing device, end user computing devices 102a-102n may be any type of computing device such as a cell phone, smart phone, smart watch, laptop, mobile computer, desktop computer, personal computer, PDA, music player or game player device.

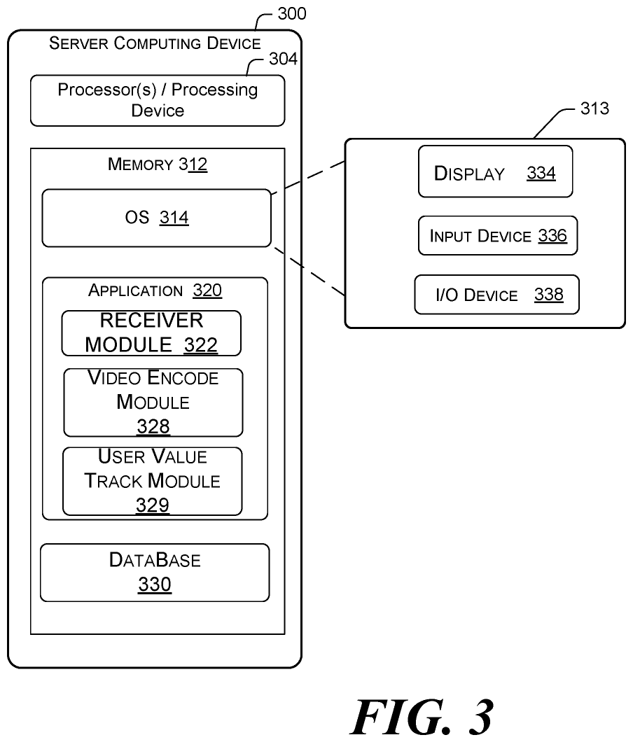

In one implementation, server computing device 108 includes one or more processors (See FIG. 3) and computer memory containing software application 112 which when executed by the processors, allows server computing device 108 to communicate to the end user computing devices 102a-102n via the network, to receive indications from tracking devices 103a-103n used by the end users. The indications from the end user computing devices 102a-102n may be an indication of a tracking of user including the user's location, information regarding a picture/streamed video watched (such as the video skew) by a user, and verification the user is or was watching the video while displaying the video.

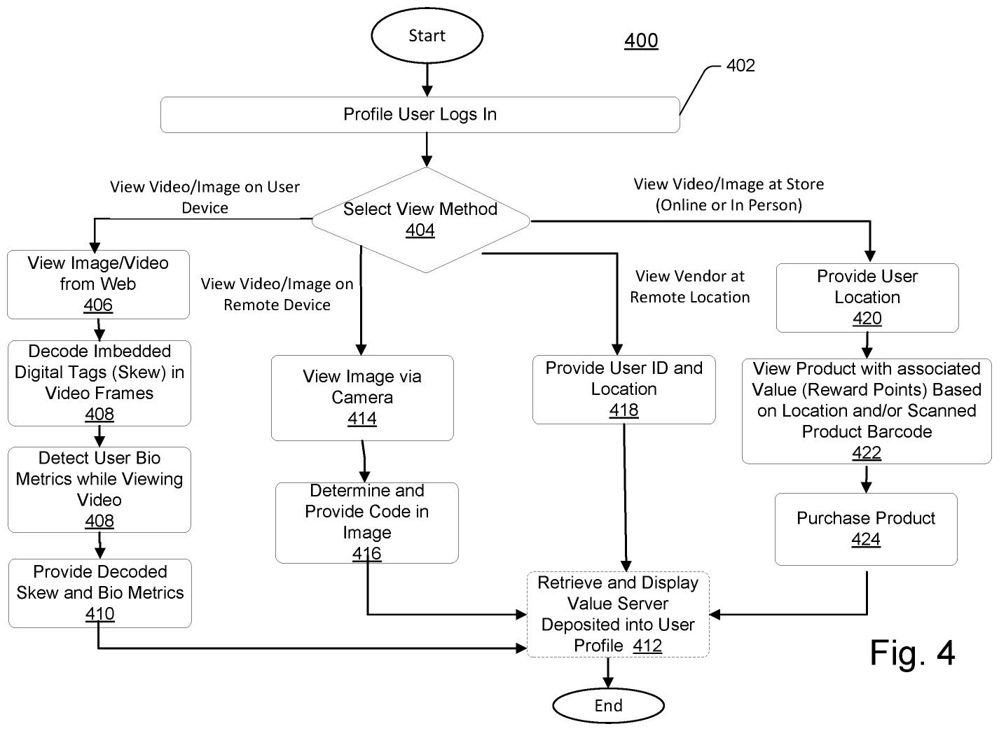

End user computing devices 102a-102n receive information from the tracking devices 103a-103n and facilitate the communication of server computing device 108 to the end user computing devices 102a-102n via the network. End user computing devices 102a-102n receive indications from tracking devices 103a-103n, and selections from the user as provided in detail in connection with FIG. 4.

The server computing device 108 may receive a tracking signal from one or more of the end user computing devices 102a-102n (including a mobile computing device) that indicate tracking activity from a tracking devices 103a-103n of multiple users as described in connection with FIG. 4.

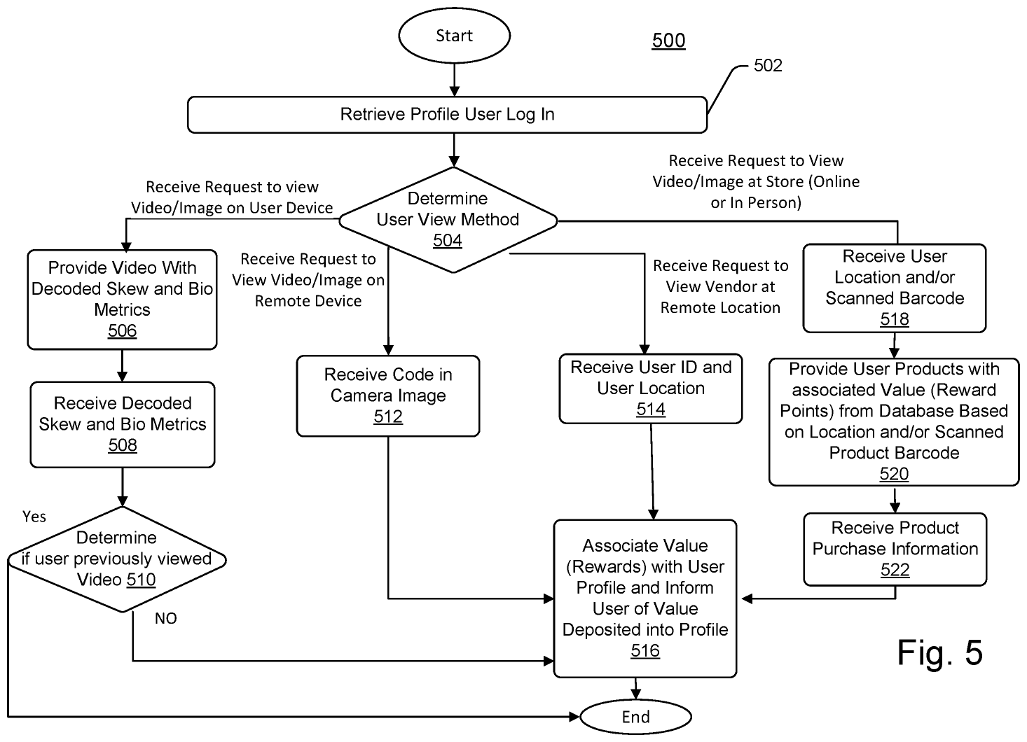

The server computing device 108 may provide product information and Value (reward) information to devices 103a-103n. Further details of this computation are described in connection with FIG. 5. In one implementation, the server computing device 108 communicates to the one or more end user computing devices 102a-102n as described in FIG. 5.

Although only three end user computer devices 102a-102n, are described, the server computing device 108 may send information (as described in connection with FIG. 5) to the end user computing devices 102a-102n, or to any device via the internet, via a company intranet, or via the World Wide Web.

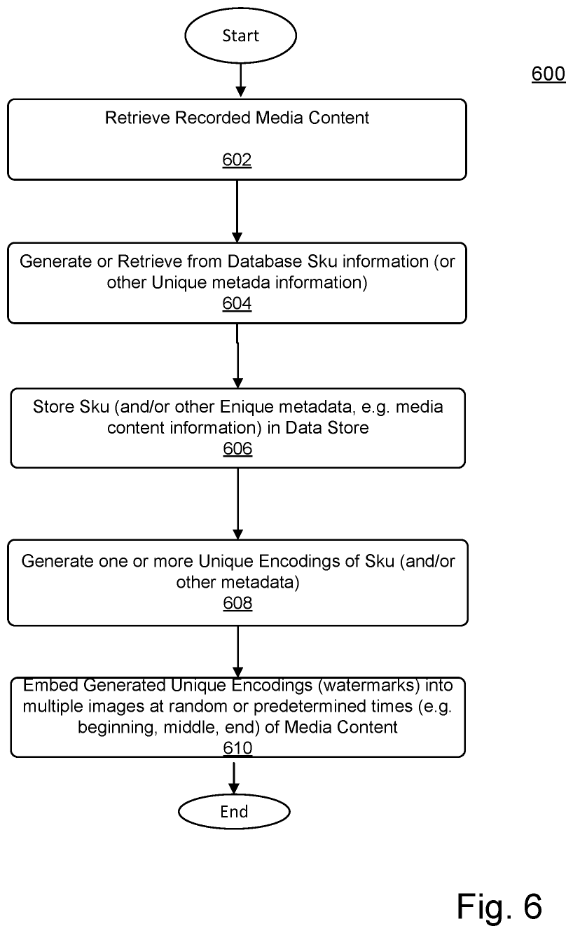

The server computing device 108 receives indications via network 104 from end user computing device 102a and end user computing device 102n. Server computing device 108 may also encode media information for viewing as described in FIG. 6.

### Example Personal Computing Device Architecture

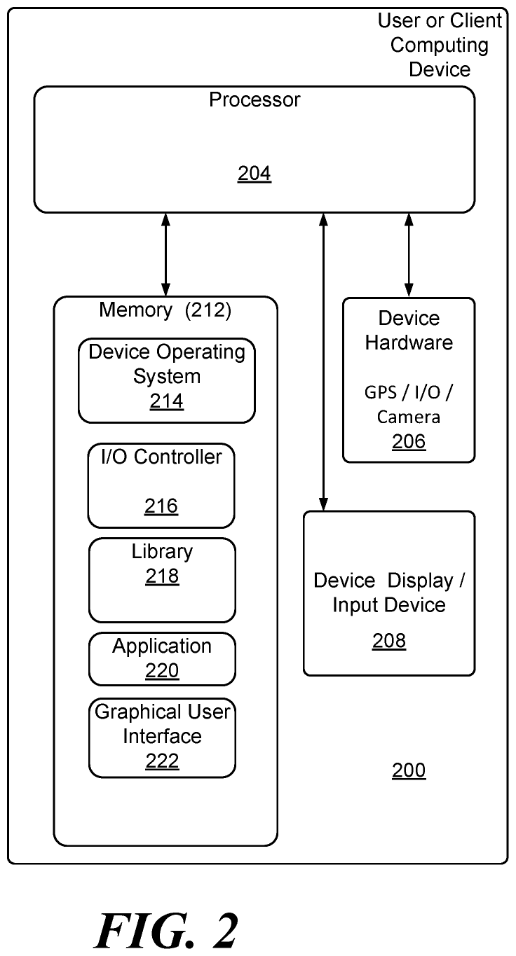

In FIG. 2 there are illustrated selected modules in personal computing device 200 (end user computing devices 102a-102n of FIG. 1) and biometric device (biometric detection devices and/or cameras 103a-n of FIG. 1) in hardware 206. Personal computing device 200 includes a processing device 204, memory 212, hardware 206 and display/input device 208. Processing device 204 or processor may include a microprocessor, microcontroller or any such device for accessing memory 212, device hardware 206 and display/input device 208. Processing device 204 has processing capabilities and memory suitable to store and execute computer-executable instructions. In one example, processing device 204 includes one or more processors.

Processing device 204 executes instructions stored in memory 212, and in response thereto, processes signals from hardware 206 and display/input device 208. Hardware 206 may include network and communication circuitry for communicating with network 104 (FIG. 1). Display/Input device 208 receives inputs from a user of one of the end user computing devices 102a-102n (See FIG. 1) (personal computing device 200) and may include a keyboard, mouse, track pad, microphone, audio input device, video input device, or touch screen display. Display/input device 208 may include an LED (Light emitting diode), LCD (Liquid crystal display), CRT (cathode ray tube) or any type of display device.

Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium (including a non-transitory computer readable storage medium) which can be used to store the desired information, and which can be accessed by a computer system.

Modules stored in memory 212 of the personal computing device 200 may include an operating system 214, an I/O controller 216, a library 218, a browser application 220 and a graphical user interface 222. Operating system 214 may be used by application 220 to operate personal computing device 200. I/O controller may provide drivers for personal computing device 200 to communicate with hardware tracking device 206 or display/input device 208. Library 218 may include preconfigured parameters (or set by the user before or after initial operation) such as personal computing device operating parameters and configurations. Browser application may include a generally known network browser (including, but not limited to, Internet Explorer, Firefox, Chrome, or Safari) for displaying articles manifested as web pages received from the network or indications from tracking device 206.

When application 220 is executed on the personal computing device 200, it uses the processing device 204 and instructions in blocks (also referred to as modules 402-424) that are shown in FIG. 4.

### Example Architecture

In FIG. 3 there are illustrated selected modules in host computing device or server 300 (Server Computing Device 108 of FIG. 1) using process 500 shown in FIG. 5. Host computing device or server 300 includes a processing device 304, memory 312, and hardware 313. Processing device 304 may include one or more microprocessors, microcontrollers or any such devices for accessing memory 312 or hardware 313. Processing device 304 has processing capabilities and memory 312 suitable to store and execute computer-executable instructions.

Processing device 304 executes instruction stored in memory 312, and in response thereto, processes signals (e.g., binary logic levels) from hardware 313. Hardware 313 may include a display device 334, input device 336 and an I/O device 338. I/O device 338 may include a network and communication circuitry including a transmitter and receiver for communicating with network 104. Input device 336 receives inputs from a user of the host computing device or server 300 and may include a keyboard, mouse, track pad, microphone, audio input device, video input device, or touch screen display. Display device 334 may include an LED, LCD, CRT, or any type of display device.

Memory 312 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information, and which can be accessed by a computer system.

Stored in memory 312 of the hosting device or server 300 may include an operating system 314, application 320 and a library of other applications such as a database 330. Operating system 314 may be used by application 320 to operate server 300. The operating system 314 may include drivers for server 300 to communicate with input device 336 and I/O device 338. Database 330 may include preconfigured parameters (or set by the user before or after initial operation) such web site operating parameters, web site libraries, HTML (Hyper Text Markup Language) libraries, API's (Application program interface) and configurations.

Stored in the database in memory 312 are the tracking information regarding the type of tracking devices, supported drivers for the biometric devices and profile information regarding the users-subscribers.

Application 320 includes a receiver module 322, a video encode module 328 and a user value track module 329. Receiver module 322 and user value track module 329 are described in FIG. 5 in process 500. Video encode module 328 is described in FIG. 6 in process 600. When application 320 is executed on the computing device or server 300, it uses the processing device 304 (also referred to herein as processor 304) and instructions in blocks/modules 502-522 that are shown in FIG. 5, or instructions in blocks/modules 602-610 that are shown in FIG. 6.

The exemplary processes in FIGS. 4-6 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4-6, although it may be implemented in other system architectures.

Referring to FIG. 4, a flowchart of process 400 performed by processing device 204 when executing the software instructions in application 220 is shown. Process 400 includes blocks 402-424.

In the process 400, in block 402 the user with the personal computing device 200 (such a smart phone or a personal computer) (FIG. 2) connects via the web to the server and sets a user profile and/or logs into the server. The initially created profile of the user may be provided to computing device or server 300.

In block 404, a user (e.g., member) using a personal computing device 200 selects a method of viewing an image and/or streamed video, e.g., view a view/image on a personal computing device 200, view video image/video on a remote device, view a vendor sign at a remote location or view video/image at an online store or in person at the store.

If the user selects to view video/image on users of personal computing device 200, then in block 406, the user views the image/view from the web or network.

In block 408, personal computing device 200 decodes one or more digital tags imbedded in the image or one or more video frames (multiple frames) in streamed video. The tags could be disposed at the beginning, middle or end of the video or be placed in the video at random locations. The digital tags may be watermarks indicating a particular skew of the image and/or indicate other metadata about the image (e.g., version of the image, date the image was recorded, URL listing image location on web, copyright information, author, or image owner, etc.). Alternatively, the digital tags may be indicated by an encoding method of the video or video image.

In block 410, personal computing device 200 detects bio metrics of a user/member (such as face detection, eye detection) viewing the video using a camera connected to personal computing device 200 or another bio metric device. The device may be activated to view the biometric device simultaneously and/or concurrently when the digital tag or watermark is displayed or detected to ensure the user/member is viewing the video image and continuously view a video image which the video is being displayed. Viewing the biometric device simultaneously with when the digital tag or water mark is displayed on a screen provides an indication of which frames of the video image are viewed by the user/member.

In block 412, the decoded skew and/or other detected metadata, user profile information and/or bio metric information may be provided to the server via the web. The server may then add (deposit) this decoded skew and/or other detected metadata or a computed value (indicating a reward) to the user's profile. Such value may be stored along with metadata at a location on the web which may only be accessed using an NFT (Non-fungible token).

Optionally in block 418, the member/user retrieves from the server via the network and displays on personal computing device 200 the value deposited into the user profile.

If the user in block 404 selects to view a video and/or image on a remote device, in block 414 personal computing device 200 imports the image/video with a camera coupled with (or built into) personal computing device 200.

In block 416, personal computing device 200 determines the presence of a code in the image or video. Such code may be displayed as a URL or may be encoded in the image as a watermark. After block 416, personal computing device 200 may optionally execute block 418 as previously described.

If the user selected in block 404 to view vendor at a remote location, in block 410 personal computing device 200 provides the user ID/profile information and user location information to server 300 via the network. After block 410, personal computing device 200 may optionally execute block 418 as previously described.

If the user selected in block 404 to view a video/image at an online store or a local retail store, in block 420 personal computing device 200 detects the user location (using a GPS locator or other location sensor in device hardware 206. Such location data may be transmitted to server 300 via network 104.

In block 422, the personal computing device 200 based on an input from the user, sends a request for product information with an associate value (reward points) from server 300. Personal computing device 200 may send via network 104 with the request bar code or other product information based on a scanning of a local product. Server 300 may provide the requested product information based on location data and bar code/additional product information along with a determined Value (reward).

In block 424, the user sends information to server 300 to purchase the product or to indicate a purchase of the product (user purchase product information). After block 424, personal computing device 200 may optionally execute block 418 as previously described.

Referring to FIG. 5, a flowchart of process 500 performed by processing device 304 when executing the software instructions in application 320 is shown. Process 500 includes blocks 502-522. When application 320 is executed on the computing device or server 300, it uses the processing device 304 and instructions in modules 502-522 that are shown in FIG. 5.

In the process 500, the computing device or server 300 (FIG. 3) in block 502 retrieves user profile and login information received from personal computing device 200 via network 104.

In block 504, server 300 receives from a user (e.g., member) using a personal computing device 200 a selected view method e.g. view an image on personal computing device 200, view video image/video on a remote device, view a vendor sign at a remote location or view a video/image at an online store or in person at the store.

If server receives a request indicating the user selected to view video/image on the users of personal computing device 200, then in block 506, server 300 provides the user a video with encoded skew/metadata on the user personal computing device 200 via network 104 so the user can view image.

In block 508, server 300 receives the decoded skew and/or biometric to verify the user viewed the entire video.

In block 510, a determination is made as to whether the user has previously viewed the video and if yes, no value is provided. The determination is no, then in block 516 a value (reward) associated with the skew is computed by the server 300 (such value may be predetermined, or computed based on the length of the video, encoded image identifying information, unencoded image identifying information, user location information, and/or user purchase product information) provided and deposited or added to the user's profile by server 300. Such value may be stored along with metadata at a location on the web or in a data store which may only be accessed using an NFT (Non-fungible token).

If server 300 receives a request to view video/image on the users of personal computing device 200, then in block 512 the server receives a code from personal computing device 200 indicating the camera image. Then block 516 is executed.

If server 300 receives a request to view vendor information located at a remote location, server 300, in block 514 receives user identification information and user location information. Then block 516 is executed.

If server 300 receives a request to view video/image at a store (either online or in person) on the users of personal computing device 200, then in block 518 server 300 receives the user's location information and/or scanned barcode information or product information.

In block 520, server 300 provides the user of personal computing device 200 products and their associated value (reward) from a database coupled with the server 300. Such user products and value provided is based on user received location data and/or scanned product information, e.g., a product barcode.

In block 522, the server 300 receives product purchase information from the user of personal computing device 200 and stores it with the user's profile. Then block 516 is executed.

Referring to FIG. 6, a flowchart of process 600 performed by processing device 304 when executing the software instructions in application 320 is shown. Process 600 includes blocks 602-610. When application 320 is executed on the computing device or server 300, it uses the processing device 304 and instructions in modules 602-610 that are shown in FIG. 6.

In process 600, the server 300 (FIG. 3) in block 602 retrieves recorded media content to be encoded.

In block 604, server 300 generates or retrieves from a database skew information (or other unique metadata information) for encoding in media.

In block 606, the skew (or other unique metadata information such as media content information (time of media, author, data media is recorded, owner of media, copyright information) is stored in a data store for later retrieval.

In block 608, server 300 generates one or more unique encodings of skew and/or other meta data. Such encoding may be encrypted or in a format used to generate a watermark.

In block 610, the unique encodings are embedded into a few or all of the multiple images of a video (media content) at random or predetermined time intervals (beginning, middle or end). Such encodings may be inserted in the images in the form of a digital watermark using known digital watermarking techniques.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion but should be defined by the appended claims.

What is claimed is:

1. A method for tracking a user's behavior comprising:
detecting with a computing device at least one of image identifying information encoded in an image viewed by the user, user location information, and user purchase product information;
detecting user identifying information;
transmitting via a network to one or more remote computing devices the detected at least one of the image identifying information, user location information, and user purchase product information concurrently with the user identifying information;
computing using the one or more remote computing devices a value based on the detected at least one of encoded image identifying information, user location information, and user purchase product information; and
the value with the user identifying information in a memory using at least one of the one or more remote computing devices.

2. The method as recited in claim 1, wherein at least one of image identifying information encoded in an image viewed by the user is encoded in one or more images in a streamed video.

3. The method as recited in claim 2, wherein at least one of image identifying information encoded in an image viewed by the user is encoded using encryption.

4. The method as recited in claim 1, wherein user identifying information is detected using a bio tracking device.

5. The method as recited in claim 4, further comprising detecting user identifying information while the image is being viewed by the user.

6. The method as recited in claim 2, further comprising detecting encoding in multiple frames of images being viewed by the user.

7. The method as recited in claim 6, further comprising providing an indication to one or more remote computing devices and indication of which frames of the image are being viewed by the user.

8. The method as recited in claim 1, wherein user identifying information is detected using camera.

9. An apparatus for tracking a user's behavior comprising:
a computing device configured to detect at least one of image identifying information encoded in an image viewed by the user, user location information, and user purchase product information;
a bio tracking device configured to detect user identifying information while the user is viewing image;
a transmitter to transmit via a network to one or more remote computing devices the detected at least one of the image identifying information, user location information, and user purchase product information concurrently with the user identifying information; and
at least one of the remote computing devices to compute a value based on the detected at least one of encoded image identifying information, user location information, and user purchase product information, said remote computing device configured to save the value with the user identifying information in a memory using the at least one of the one or more remote computing devices.

10. The apparatus as recited in claim 9, wherein the image identifying information encoded in the image viewed by the user is encoded in one or more images in a streamed video.

11. The apparatus as recited in claim 10, wherein the image identifying information encoded in the image viewed by the user is encoded using encryption.

12. The apparatus as recited in claim 10, wherein the computing device is configured to detect encoding in multiple frames of images being viewed by the user.

13. The apparatus as recited in claim 12, wherein the transmitter is configured to send a signal to one or more remote computing devices indicating which frames of the image are being viewed by the user.

14. The apparatus as recited in claim 9, wherein the bio tracking device includes a camera.

15. A system for tracking a user's behavior comprising:
one or more remote computing devices configured to detect at least one of image identifying information encoded in an image viewed by the user, user location information, and user purchase product information;
a bio tracking device configured to detect user identifying information while the user is viewing image;
a transmitter to transmit via a network to one or more remote computing devices the detected at least one of the image identifying information, user location information, and user purchase product information concurrently with the user identifying information; and
the one or more remote computing devices to compute a value based on the detected at least one of encoded image identifying information, user location information, and user purchase product information, said one or more remote computing devices configured to save the value with the user identifying information in a memory using at least one of the one or more remote computing devices.

16. The system as recited in claim 15, wherein the image identifying information encoded in the image viewed by the user is encoded in one or more images in a streamed video.

17. The system as recited in claim 16, wherein the image identifying information encoded in the image viewed by the user is encoded using encryption.

18. The system as recited in claim 15, wherein at least one of the one or more remote computing devices is configured to detect encoding in multiple frames of images being viewed by the user.

19. The system as recited in claim 18, wherein the transmitter is configured to send a signal to the one or more remote computing devices indicating which frames of the image are viewed by the user.

20. The system as recited in claim 15, wherein the bio tracking device includes a camera.
